(19) United States
(12) Patent Application Publication
(10) Pub. No.: US 2026/0089530 A1
(43) Pub. Date: Mar. 26, 2026

(54) MEASUREMENT REPORTING METHOD AND APPARATUS, AND COMMUNICATION DEVICE

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/110,848

(22) PCT Filed: Sep. 13, 2022
(86) PCT No.: PCT/CN2022/118534

§ 371 Date: Mar. 12, 2025

(51) Int. Cl. H04W 24/10

(52) U.S. Cl. CPC H04W 24/10

(57) ABSTRACT

A measurement reporting method includes: performing a Radio Resource Management (RRM) measurement; determining at least one first cell that fulfills a measurement event; and initiating measurement reporting at least according to at least one second cell in the at least one first cell. The at least one second cell is at least one cell in the at least one first cell which was not reported in last measurement reporting.

### CROSS REFERENCE TO RELATED APPLICATION

The present application is a U.S. National Stage of International Application No. PCT/CN2022/118534, filed on Sep. 13, 2022, the contents of which are incorporated herein by reference in its entirety.

### TECHNICAL FIELD

The present disclosure relates to the wireless communication technical field, and in particular to a measurement reporting method and apparatus and a communication device.

### BACKGROUND

In a mobile communication system, movement of a terminal device causes a channel state around the terminal device to change all the time. In order to support mobility of the terminal device and obtain channel states of the terminal device's serving cell and surrounding cells in a timely manner, a network configures the terminal device to perform a Radio Resource Management (RRM) measurement. During the RRM measurement procedure, the network sends measurement configuration information to the terminal device, and the terminal device performs an intra-frequency measurement, an inter-frequency measurement, or an inter-system measurement according to the content of the measurement configuration information. When the number of cell(s) that fulfills(fulfill) a measurement event is greater than a configured number, the terminal device reports a measurement report to the network.

### SUMMARY

According to a first aspect of the present disclosure, a measurement reporting method is provided. The method may be applied to a terminal device side in a communication system. The method may include: performing a RRM measurement; determining at least one first cell that fulfills a measurement event; and initiating measurement reporting at least according to at least one second cell in the at least one first cell, wherein the at least one second cell is at least one cell in the at least one first cell which was not reported in last measurement reporting.

According to a second aspect of the present disclosure, a measurement reporting method is provided. The method may be applied to a network device side in a communication system. The method may include: sending measurement configuration information to a terminal device, where the measurement configuration information includes a second threshold, the second threshold is the minimum value of the number of at least one second cell for the terminal device to initiate measurement reporting, the at least one second cell is at least one triggering cell in at least one first cell that was not reported in last measurement reporting, and the at least one first cell is at least one triggering cell that fulfills a measurement event; and receiving a measurement report reported by the terminal device.

According to a further aspect of the present disclosure, a communication device is provided, such as a terminal device. The communication device includes: an antenna; a memory; and a processor which is connected to the antenna and the memory respectively and is configured to control reception and transmission of the antenna by executing computer-executable instructions stored in the memory, and is capable of implementing the method as described in the first aspect of the present disclosure.

According to a further aspect of the present disclosure, a communication device is provided, such as a network device. The communication device includes: an antenna; a memory; and a processor which is connected to the antenna and the memory respectively and is configured to control reception and transmission of the antenna by executing computer-executable instructions stored in the memory, and is capable of implement the method as described in the second aspect of the present disclosure.

According to a further aspect of the present disclosure, a non-transitory computer storage medium is provided. The computer storage medium stores computer executable instructions. After the computer executable instructions are executed by a processor, the method as described in any one of the first to second aspects of the present disclosure.

It should be understood that the seventh to fifteenth aspects of the present disclosure are consistent with the technical solutions of the first to sixth aspects of the present disclosure, and the beneficial effects achieved by various aspects and corresponding feasible implementations are similar, and repeated descriptions will be omitted.

### BRIEF DESCRIPTION OF THE DRAWINGS

FIG. 1 is a schematic diagram of a structure of a communication system in an embodiment of the present disclosure;

FIG. 2 is a schematic diagram of an implementation process of a measurement reporting method in an embodiment of the present disclosure;

FIG. 3 is a schematic diagram of an implementation process of a measurement reporting method in an embodiment of the present disclosure;

FIG. 4 is a schematic diagram of an implementation process of a measurement reporting method in an embodiment of the present disclosure;

FIG. 5 is a schematic diagram of an implementation process of a measurement reporting method in an embodiment of the present disclosure;

FIG. 6 is a schematic diagram of an implementation process of a measurement reporting method in an embodiment of the present disclosure;

FIG. 7 is a schematic diagram of an implementation process of a measurement reporting method in an embodiment of the present disclosure;

FIG. 8 is a schematic diagram of an implementation process of a measurement reporting method in an embodiment of the present disclosure;

FIG. 9 is a schematic diagram of an implementation process of a measurement reporting method in an embodiment of the present disclosure;

FIG. 10 is a schematic diagram of a structure of a measurement reporting apparatus in an embodiment of the present disclosure;

FIG. 11 is a schematic diagram of a structure of a communication device in an embodiment of the present disclosure;

FIG. 12 is a schematic diagram of a structure of a terminal device in an embodiment of the present disclosure;

FIG. 13 is a schematic diagram of a structure of a network device in an embodiment of the present disclosure.

### DETAILED DESCRIPTION

Here, example embodiments will be described in detail, examples of which are shown in accompanying drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are only examples of apparatuses and methods consistent with some aspects of the embodiments of the present disclosure.

Terms used in the embodiments of the present disclosure are only for the purpose of describing specific embodiments, and are not intended to limit the embodiments of the present disclosure. The singular forms of “a/an” and “the” used in the embodiments of the present disclosure are also intended to include plural forms, unless the context clearly indicates other meanings. It should also be understood that the term “and/or” used herein refers to and includes any or all possible combinations of one or more associated listed items.

It should be understood that although terms “first”, “second”, “third”, etc. may be used to describe various information in the embodiments of the present disclosure, such information should not be limited to these terms. These terms are only used to distinguish the same type of information from each other. For example, without departing from the scope of the embodiments of the present disclosure, “first information” may also be referred to as “second information”, and similarly, “second information” may also be referred to as “first information”. Depending on the context, the word “if” as used herein may be interpreted as “when” or “in a case where . . . ” or “in response to determining . . . ”.

Furthermore, in the description of the embodiments of the present disclosure, “and/or” is only a description of an association relationship of associated objects, indicating that three relationships may exist. For example, A and/or B may represent: A exists alone, A and B exist at the same time, and B exists alone. In addition, in the description of the embodiments of the present disclosure, “multiple” may refer to two or more than two.

The technical solutions provided in the embodiments of the present disclosure may be applied to wireless communication between communication devices. The wireless communication between communication devices may include: wireless communication between a network device and a terminal device, wireless communication between a network device and a network device, and wireless communication between a terminal device and a terminal device. In the embodiments of the present disclosure, the term “wireless communication” may also be referred to as “communication”, and the term “communication” may also be described as “data transmission”, “information transmission” or “transmission”.

The embodiments of the present disclosure list multiple implementations to clearly illustrate the technical solutions of the embodiments of the present disclosure. Of course, those skilled in the art can understand that the multiple embodiments provided by the embodiments of the present disclosure may be performed independently, or may be combined with methods of other embodiments among the embodiments of the present disclosure, or an embodiment performed independently or an embodiment performed with other embodiment(s) may be performed in combination with some methods in other related technologies; the embodiments of the present disclosure do not limit this.

In an embodiment of the present disclosure, a non-serving cell may also be referred to as a neighboring cell, and a neighboring cell may also be referred to as a non-serving cell.

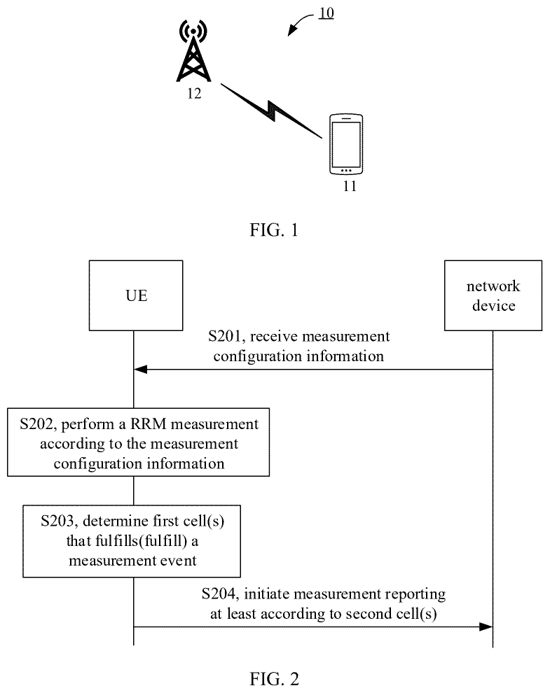

An embodiment of the present disclosure provides a communication system. The communication system may be a communication system using a cellular mobile communication technology. FIG. 1 is a schematic diagram of a structure of a communication system in the embodiment of the present disclosure. Referring to FIG. 1, the communication system 10 may include: a terminal device 11 and a network device 12.

In an embodiment, the terminal device 11 may be a device that provides voice or data connectivity to a user. In some embodiments, the terminal device may also be referred to as User Equipment (UE), mobile station, subscriber unit, station or terminal equipment (TE), etc. The terminal device may be a cellular phone, a Personal Digital Assistant (PDA), a wireless modem, a handheld device, a laptop computer, a cordless phone, a Wireless Local Loop (WLL) station or a tablet computer, etc. With the developments of wireless communication technologies, device(s) that can access a communication system, communicate with a network side of a communication system, or communicate with other device(s) through a communication system is(are) the terminal device in the embodiments of the present disclosure, for example, a terminal device and a car in intelligent transportation, a household device in a smart home, an electric meter reading instrument in smart grids, a voltage monitoring instrument, an environmental monitoring instrument, a video monitoring instrument in an intelligent complete network, a cash register, etc. In an embodiment of the present disclosure, the terminal device may communicate with a network device, and multiple terminal devices may also communicate with each other. The terminal device may be statically fixed or mobile. The embodiments of the present disclosure are described by taking a terminal which is UE as an example.

The network device 12 may be a device at an access network side for supporting terminal device(s) to access the communication system. For example, the network device may be an evolved NodeB (eNB) in a communication system using a 4G access technology, a next generation nodeB (gNB) in a communication system using a 5G access technology, a Transmission Reception Point (TRP), a relay node, an Access Point (AP), etc.

In the above communication system 10, movement of a terminal device (such as UE) causes the channel state around the terminal device to change all the time. In order to support the mobility of the UE and obtain the channel state(s) of cell(s) around the UE in a timely manner, the network device configures the UE to perform a RRM measurement. UEs in an idle state and in an inactive state autonomously perform cell selection or cell reselection based on measurement result(s) of the RRM measurement, and a UE in a connected state reports the RRM measurement results to the network device to assist the network device in making decisions on cell handover. During the measurement procedure of the UE in the connected state, the network device (such as a base station) sends measurement configuration information to the UE in the connected state through Radio Resource Control (RRC) signaling. The UE performs an intra-frequency measurement, an inter-frequency measurement or an inter-system measurement according to the content of the measurement configuration information, and then the UE reports the measurement result to the network device.

In some possible implementations, a reporting trigger type of the measurement (such as a reportType parameter or a triggerType parameter) may be event-triggered reporting (eventTriggered or event).

As an example, RRM events (also referred to as measurement events, reporting events, etc.) supported in the 5G communication system include: Event A1, Event A2, Event A3, Event A4, Event A5, Event A6, and Event B1 or Event B2 for inter-system. Of course, the communication system described in the embodiments of the present disclosure may also support other RRM events, which are not specifically limited.
Event A1: a measurement result of the serving cell is greater than a threshold;
Event A2: a measurement result of the serving cell is less than a threshold;
Event A3: a measurement result of a neighboring cell is better than a measurement result of a special cell (SpCell) (which may be a Primary Serving Cell (PCell) or a Primary Secondary Cell (PSCell));
Event A4: a measurement result of a neighboring cell is greater than a threshold;
Event A5: a measurement result of a SpCell (which may be a PCell or a PSCell) is less than a threshold1, and a measurement result of a neighboring cell is greater than a threshold2;
Event A6: a measurement result of a neighboring cell is better than a measurement result of a secondary serving cell (SCell);
Event B1: a measurement result of a neighboring inter-system cell is greater than a threshold;
Event B2: a measurement result of a Primary Serving Cell (PCell) is less than a threshold1, and meanwhile a measurement result of a neighboring inter-system cell is greater than a threshold 2.

In an embodiment, event-triggered reporting may be divided into one-time event-triggered reporting and periodical event-triggered reporting.

When an event triggers one-time reporting, the UE triggers reporting of a measurement report only when it is fulfilled that a measurement event configured by a network enters a threshold and lasts for a period of time. The procedure ends after the measurement report is sent once. In this case, the measurement reporting configuration configured by the network device for the UE is: the trigger type (triggertype) is “event”; a measurement event in A1 to A6 or B1 to B2 and its threshold parameter(s); the number of times of reporting is equal to 1; the UE ignores the reporting interval configuration.

When an event triggers periodical reporting, the UE triggers reporting of a measurement report only when it is fulfilled that a measurement event configured by a network enters a threshold and lasts for a period of time. After reporting is triggered, a timer between multiple measurements and a counter for counting the number of times of measurements are turned on until the number of times of reporting reaches the requirement and the procedure ends. In this case, the measurement reporting configuration configured by the network device for the UE is: the trigger type is “event”; a measurement event in A1 to A6 or B1 to B2 and its threshold parameter(s); the number of times of reporting is greater than 1; the reporting interval is valid, and the periodical reporting timer is set according to the configured interval parameter.

As the global interest in Unmanned Aerial Vehicle (UAV)-based services increases dramatically, including various UAV operations, personal entertainment of flying experience, cargo delivery, etc. As the basis of these services, remote control and data transmission capabilities are key aspects of enhancement, which is of interest to service providers/operators as well as UAV manufacturers.

Since there is a line-of-sight connection between an aerial UE (such as UVA) and many base stations, strong interference may be caused to neighboring cell(s) or interference caused by neighboring cell(s) may exist. Interference detection may be performed in a base station or may be estimated by the UE. In base station-based detection, the base station needs to negotiate with neighboring cell(s) and collect interference from neighboring cell(s) to know that the aerial UE has begun to interfere with multiple cells. Although this method is more accurate, this method has poor real-time performance and high latency, and requires signaling interaction between base stations. Therefore, a UE-based solution is adopted. The UE may estimate the interference to other cell(s) by performing downlink measurements on neighboring cell(s). If there is reciprocity between uplink and downlink, estimation based on measurements is a good method. However, since an aerial UE may cause interference to multiple neighboring cells, the frequency of measurement reporting may increase. In order to solve the problem of frequent triggering of measurement report(s), the UE may trigger measurement reporting after the number of cell(s) that fulfills(fulfill) the measurement event meets the configured number of cell(s), thereby reducing the number of times of triggering measurement reporting.

However, in a corresponding measurement reporting procedure, for example, in a scenario where the terminal device moves at high speed, the measurement reporting is triggered only when the number of cell(s) that fulfills(fulfill) the measurement event changes from less than the configured number to greater than or equal to the configured number. Even if the number of cell(s) that fulfills(fulfill) the measurement event subsequently continues to be greater than the configured number, the UE will not trigger measurement reporting. Thus, the network cannot know all the cell(s) that fulfills(fulfill) the measurement event, and a situation of “underreporting” or “missing reporting” may occur. That is, there are some cells that fulfill a triggering condition but do not trigger corresponding measurement reporting. Therefore, the performance of measurement reporting is affected, and thereby the performance of the interference detection is affected.

In order to solve the above technical problem, an embodiment of the present disclosure provides a measurement reporting method. The method may be applied to the UE side of the above communication system.

FIG. 2 is a schematic diagram of an implementation process of a measurement reporting method in an embodiment of the present disclosure. Referring to FIG. 2, the method may include: S201 to S204.

In S201, a UE receives measurement configuration information sent by a network device (such as a base station).

It can be understood that the network device configures configuration information for the UE to perform cell measurement, that is, the measurement configuration information. As an example, the network device may carry the measurement configuration information in RRC signaling and send it to the UE.

As an example, the measurement configuration information may further include: a measurement object, a reporting configuration, and a measurement identity for associating the measurement object and the reporting configuration, etc. The reporting configuration may include parameters such as a measurement event, the maximum number of times of reporting, and a reporting period.

In S202, the UE performs a RRM measurement according to the measurement configuration information.

It can be understood that the UE performs the RRM measurement according to the measurement configuration information to obtain a measurement result of at least one cell associated with the UE. These measurement results can assist the network in making a handover decision.

In S203, the UE determines first cell(s) that fulfills(fulfill) a measurement event.

The first cell(s) refers to cell(s) that fulfills(fulfill) the measurement event (also described as triggering cell (TriggeringCells)). The first cell(s) may be a serving cell of the UE or a neighboring cell of the UE (also referred to as a non-serving cell). As an example, the first cell(s) is(are) included in a first triggering cell list, for example, the first triggering cell list may be expressed as cellsTriggeredList.

Here, the measurement event may be at least one of the above Events A1 to A6 and Events B1 to B2. As an example, the measurement event may be Event A3, Event A4 or Event A5. Of course, the measurement event is not limited to the above events, and the embodiments of the present disclosure do not limit the specific measurement events.

It can be understood that after the UE obtains at least one cell measurement result through S202, the UE may determine which measurement event these measurement results fulfill, that is, the UE may determine the measurement result(s) that triggers(trigger) a certain measurement event, and determine cell(s) corresponding to the measurement result(s) that fulfills(fulfill) the measurement event as the first cell(s).

In S204, the UE initiates measurement reporting at least according to second cell(s) in the first cell(s).

The second cell(s) is(are) cell(s) in the first cell(s) that was(were) not reported in last measurement reporting, that is, unreported cell(s) obtained by the current measurement (hereinafter referred to as unreported cell(s)). The second cell(s) may be a serving cell of the UE or a neighboring cell of the UE. As an example, the second cell(s) is(are) included in a second triggering cell list, for example, the second triggering cell list is expressed as newcellsTriggeredList.

It should be noted that the cell(s) that was(were) not reported in last measurement reporting may be understood as cell(s) that the UE has never reported in historical measurement reporting, that is, the current reporting is the reporting for the first time, or may be understood as cell(s) that the UE has reported in historical measurement reporting but was(were) not reported in the last measurement reporting.

In the present disclosure, cell(s) that was(were) not reported in last measurement reporting (that is, new cell(s) that fulfills(fulfill) the measurement event) is(are) determined in first cell(s) that fulfills(fulfill) a measurement event, and then measurement reporting is initiated based on the new cell(s). In this way, after measuring the unreported cell(s), the terminal device can decide to initiate measurement reporting to fully report to the network the measurement report(s) of the cell(s) associated with the terminal device, so that the network can fully understand the channel state(s) of the cell(s) associated with the terminal device, thereby improving system performance.

In an embodiment, in a case where the reporting corresponding to a measurement identity is the reporting for the first time, or in a case where the corresponding measurement identity (or this measurement reporting procedure) has not previously triggered measurement reporting, then cell(s) that fulfills(fulfill) the measurement event is(are) all unreported cells. That is, all of the first cell(s) may be understood as the second cell(s).

In some possible implementations, after S203, the UE may also compare the first cell(s) with cell(s) reported in the last measurement reporting to determine the unreported cell(s), i.e., the second cell(s). Here, the second cell(s) may be understood as new cell(s) that fulfills(fulfill) the measurement event in the current measurement reporting compared to the last measurement reporting, or may be understood as a cell increment.

It may be understood that after determining the first cell(s), the UE further determines the second cell(s) from the first cell(s), and then the UE initiates measurement reporting at least according to the situation of the second cell(s). In this way, the UE can report measurement result(s) of all cell(s) that fulfills(fulfill) the measurement event to the network device, and the network device can more comprehensively understand the channel state(s) of the UE's serving cell and/or neighboring cell(s), thereby improving the accuracy of procedures such as cell handover, interference detection, or interference coordination or the like, and improving system performance.

In some possible implementations, S204 may include but is not limited to at least one of the following three situations:

First case: when second cell(s) exists(exist) in the first cell(s) and the number of the first cell(s) is greater than or equal to a first threshold, the UE initiates measurement reporting.

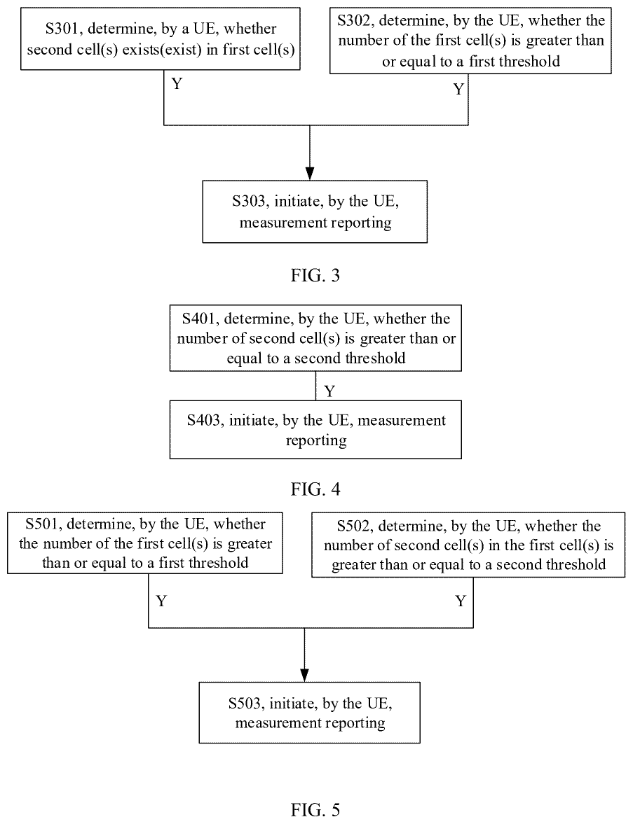

Correspondingly, FIG. 3 is a schematic diagram of an implementation process of a measurement reporting method in an embodiment of the present disclosure. Referring to FIG. 3, after S203, the method further includes: S301 to S303.

In S301, the UE determines whether second cell(s) exists(exist) in the first cell(s).

In S302, the UE determines whether the number of the first cell(s) is greater than or equal to a first threshold.

Here, the first threshold may be understood as the minimum value of the number of cell(s) that fulfills(fulfill) a measurement event. The first threshold may be configured by the network device for the UE. In an embodiment, the first threshold is included in the measurement configuration information and sent to the UE. As an example, the first threshold may be expressed as numberOfTriggeringCells.

In S303, if both the determination results in S301 and S302 are yes, the UE initiates measurement reporting.

It can be understood that the UE may first determine whether second cell(s) exists(exist) in the first cell(s), and determine whether the number of the first cell(s) is greater than or equal to the first threshold; if both determination results are yes, that is, there is(are) second cell(s) in the first cell(s), and the number of the first cell(s) is greater than the first threshold, the UE initiates the measurement reporting; otherwise, the UE does not initiate the measurement reporting. That is to say, after determining the first cell(s), the UE may determine whether there is(are) cell(s) in the first cell(s) that was(were) not reported in the last measurement reporting, that is, whether there is(are) second cell(s). If there is(are) second cell(s), it means that there is(are) new cell(s) that fulfills(fulfill) the measurement event in this measurement result. Also, the UE determines whether the number of the first cell(s) is greater than or equal to (can also be described as “not less than”) the first threshold according to the measurement result. If yes, it means that the number of cell(s) that fulfills(fulfill) the measurement event reaches a certain number, and in this case, the UE initiates the measurement reporting. It can be seen that the UE initiates the measurement reporting in a case where the unreported cell(s) is(are) obtained by the current measurement and the total number of cell(s) that fulfills(fulfill) the measurement event is greater than or equal to the first threshold. It should be noted that S301 and S302 may be performed successively or simultaneously, and the embodiments of the present disclosure do not specifically limit this.

As an example, the UE obtains cells (i.e., first cells) that fulfill the measurement event by measurement, and the cells are cell A, cell B, cell C and cell D, where cell D is a cell (i.e., a second cell) that was not reported in the last measurement reporting. The numberOfTriggeringCells carried in the measurement configuration information is 2. The UE determines through S301 that there is an unreported cell in the first cells, i.e., cell D. And, the UE determines through S302 that the number of first cells is greater than 2. Accordingly, the UE initiates measurement reporting.

As an example, the above method may be implemented using a part or all of the following processes:
1. For each measurement identity (e.g., measId) in a measurement identity list (e.g., measIdList) of a first UE variable (e.g., VarMeasConfig) storing measurement configuration
2. If the reporting type is set to event-triggered (eventTriggered), and if the corresponding reporting configuration includes a first threshold (such as numberOfTriggeringCells), and if the entry condition applicable for this event (i.e. the event corresponding to the event identity of the corresponding reporting configuration within the first UE variable) is fulfilled for one or more applicable cells for measurement values after layer 3 (L3) filtering taken during a trigger duration (for example, timeToTrigger) defined for this event within the first UE variable:
3. If the second UE variable (such as VarMeasReportList) storing the measurement report list does not include a measurement reporting entry for the measurement value for the measurement identity (the first time a cell triggers this event):
4. Include a reporting entry for the measurement value in the second UE variable for the measurement identity;
3. Include the concerned cell(s) (i.e., the first cell(s)) in the first triggering cell list (such as cellsTriggeredList) defined in the second UE variable for the measurement identity;
3. If the number of cell(s) in the first triggering cell list is greater than or equal to the first threshold:
5. Set a first count value (such as numberOfReportsSent) defined in the second UE variable for the measurement identity and used to count the number of times of measurement reporting to 0;
5. Initiate the measurement reporting procedure.

Second case: when the number of second cell(s) in the first cell(s) is greater than or equal to the second threshold, the UE initiates measurement reporting.

Correspondingly, FIG. 4 is a schematic diagram of an implementation process of a measurement reporting method in an embodiment of the present disclosure. Referring to FIG. 4, after S203, the method further includes: S401 to S402.

In S401, the UE determines whether the number of second cell(s) in the first cell(s) is greater than or equal to a second threshold.

Here, the second threshold may be understood as the minimum value of the unreported cell(s), or may also be understood as the minimum value of the number of unreported cell(s) for initiating measurement reporting. The second threshold may be configured by the network device for the UE. In an embodiment, the second threshold is included in the measurement configuration information and sent to the UE. As an example, the second threshold may be expressed as numberOfNewTriggeringCells.

In S402, if the determination result in S401 is yes, the UE initiates measurement reporting.

It can be understood that the UE may first determine the number of second cell(s) in the first cell(s), and determine whether the number of second cell(s) is greater than or equal to the second threshold, that is, whether the number of unreported cell(s) fulfills the second threshold; if yes, the UE initiates measurement reporting; otherwise, the UE does not initiate measurement reporting. That is to say, after determining the first cell(s), the UE can determine the cell(s) in the first cell(s) that was(were) not reported in the last measurement reporting, that is, the number of second cell(s). If the number of the second cell(s) is greater than or equal to the second threshold, it means that the number of new cell(s) that fulfills(fulfill) the measurement event in this measurement result reaches a certain number, and in this case, the UE initiates measurement reporting. It can be seen that the UE initiates measurement reporting in a case where the number of unreported cell(s) is greater than or equal to the second threshold, thereby further reducing the reporting frequency and saving UE power consumption.

As an example, the UE obtains cells (i.e., the first cells) that fulfill the measurement event by measurement, and the cells are cell A, cell B, cell C and cell D, where cell A, cell C, and cell D are cells (i.e., the second cells) that were not reported in the last measurement reporting. The second threshold (numberOfNewTriggeringCells) carried in the measurement configuration information is 3. Thus, the UE determines through S401 that the number of unreported cells in the first cells is 3, i.e., cell A, cell C, and cell D. Then, the UE determines through S402 that the number of second cells is equal to 3. Accordingly, the UE initiates the measurement reporting.

In an embodiment, if one or more cells fulfill a certain event (or fulfill an entry condition of a certain event), and the reporting configuration includes the second threshold, the second triggering cell list includes the corresponding cell(s), i.e., the second cell(s).

In an embodiment, if the number of cell(s) in the second triggering cell list is greater than or equal to the second threshold, at least one of the following is performed:
setting a first count value corresponding to the corresponding measurement identity to 0, where the first count value is used to count the number of times of measurement reporting;
initiating the measurement reporting procedure;
deleting all cell(s) in the second triggering list.

In another embodiment, if a cell in the second triggering cell list does not fulfill a certain event (or a leaving condition for a certain event is fulfilled), the concerned cell(s) in the second triggering cell list defined in the second UE variable for the measurement identity is(are) deleted.

As an example, the above method may be implemented using a part or all of the following processes:
1. For each measurement identity in the measurement identity list (such as measIdList) of the first UE variable (such as VarMeasConfig) storing the measurement configuration:
2. If the reporting type is set to event-triggered (eventTriggered), and if the corresponding reporting configuration includes the second threshold (such as numberOfNewTriggeringCells), and if the entry condition applicable for this event (i.e. the event corresponding to the event identity of the corresponding reporting configuration within the first UE variable) is fulfilled for one or more applicable cells for all measurement values after layer 3 (L3) filtering taken during a trigger duration (for example, timeToTrigger) defined for this event within the first UE variable:
3. If the second UE variable (such as VarMeasReportList) storing the measurement report list does not include a measurement reporting entry for the measurement value for the measurement identity (the first time a cell triggers this event):
4. Include a reporting entry for the measurement value in the second UE variable for the measurement identity;
3. Include concerned cell(s) (that is, the first cell(s)) in the first triggering cell list (such as cellsTriggeredList) defined in the second UE variable for the measurement identity;
3. Include concerned cell(s) (that is, the second cell(s)) in the second triggering cell list (such as newCellsTriggeredList) defined in the second UE variable for the measurement identity;
3. If the number of cell(s) in the second triggering cell list is greater than or equal to the second threshold (numberOf NewTriggeringCells):
5. Set a first count value (such as numberOfReportsSent) defined in the second UE variable for the measurement identity and used to count the number of times of measurement reporting to 0;
5. Initiate the measurement reporting procedure;
5. Delete all cell(s) in the second triggering cell list defined in the second UE variable for the measurement identity;
2. Otherwise, if the reporting type is set to event-triggered (eventTriggered), and if the leaving condition applicable for this event (i.e. the event corresponding to the event identity of the corresponding reporting configuration within the first UE variable) is fulfilled for one or more of the cells included in the second triggering cell list (newCellsTriggeredList) for all measurement values after layer 3 (L3) filtering taken during a trigger duration defined within the first UE variable for this event:
3. Delete the concerned cell(s) in the second triggering cell list defined in the second UE variable for the measurement identity.

Third case: when the number of the first cell(s) is greater than or equal to the first threshold and the number of the second cell(s) in the first cell(s) is greater than or equal to the second threshold, the UE initiates measurement reporting.

Correspondingly, FIG. 5 is a schematic diagram of an implementation process of a measurement reporting method in an embodiment of the present disclosure. Referring to FIG. 5, after S203, the method further includes: S501 to S503.

In S501, the UE determines whether the number of the first cell(s) is greater than or equal to the first threshold.

In S502, the UE determines whether the number of the second cell(s) in the first cell(s) is greater than or equal to the second threshold.

Here, the first threshold may be understood as the minimum value of the number of cell(s) that fulfills(fulfill) the measurement event. The first threshold may be configured by the network device for the UE. In an embodiment, the first threshold is included in the measurement configuration information and sent to the UE. As an example, the first threshold may be expressed as numberOfTriggeringCells.

In S503, if both determination results in S501 and S502 are yes, the UE initiates measurement reporting.

It can be understood that the UE may determine whether the number of the first cell(s) is greater than or equal to the first threshold, and whether the number of the second cell(s) in the first cell(s) is greater than or equal to the second threshold; if both are yes, the UE initiates measurement reporting; otherwise, the UE does not initiate measurement reporting. That is, after determining the first cell(s), the UE may determine whether the number of the first cell(s) is greater than or equal to the first threshold (can also be described as determining whether the number of the first cell(s) is not less than the first threshold according to the measurement result) according to the measurement result, and the UE may determine the second cell(s) in the first cell(s) according to the measurement result, and then determine whether the number of the second cell(s) is greater than or equal to (can also be described as “not less than”) the second threshold. If both determination results are yes, the UE initiates measurement reporting. It can be seen that the UE initiates measurement reporting in a case where the total number of cell(s) that fulfills(fulfill) the measurement event in the current measurement is greater than or equal to the first threshold, and the number of unreported cell(s) in this measurement is greater than or equal to the second threshold. In this way, the measurement reporting frequency can be further reduced and power consumption can be saved.

It should be noted that S501 and S502 may be performed successively or simultaneously, and embodiments of the present disclosure does not specifically limit this.

As an example, the UE obtains cells (i.e., the first cells) that fulfill the measurement event by measurement, and the cells are cell A, cell B, cell C and cell D, where cell C and cell D are cells (i.e., the second cells) that were not reported in the last measurement reporting. The numberOfTriggeringCells carried in the measurement configuration information is 2, and the numberOfNewTriggeringCells is 2. Thus, the UE determines through S502 that the number of first cells is greater than 2, and determines through S502 that the number of unreported cells in the first cells is equal to 2, i.e., cell C and cell D. Accordingly, the UE initiates the measurement reporting.

In an embodiment, the first threshold and the second threshold may be two different parameters. When the second threshold is 1, the number of the second cell(s) being greater than or equal to the second threshold may be understood as that a second cell exists in the first cell(s). Then, the first case mentioned above can also be described as: “when the number of the second cell(s) in the first cell(s) is greater than 1 (that is, the second threshold is 1), and the number of first cell(s) is greater than or equal to the first threshold, the UE initiates measurement reporting”.

In another embodiment, the first threshold and the second threshold may be the same parameter. In this case, the first threshold and the second threshold have the same value. Accordingly, the measurement configuration information may include only one parameter (such as the first threshold) to indicate the first threshold and the second threshold at the same time.

Of course, the UE may also initiate measurement reporting based on other situations of the second cell(s), which is not specifically limited in the embodiments of the present disclosure. The above situation is only an example of S204, and each situation may be implemented independently or in combination.

In some possible implementations, “initiating measurement reporting” described in the embodiments of the present disclosure may also be described as: “triggering a measurement reporting procedure”.

In an embodiment, “initiating measurement reporting” may include: sending, by the UE, a measurement report for the current measurement to the network device. Optionally, the measurement report may include a measurement result of the first cell(s) or a measurement result of the second cell(s).

Optionally, in response to the measurement report including the measurement result of the second cell(s), the UE sending the measurement report to the network device may be understood as: only reporting or preferentially reporting the measurement result of the second cell(s).

It can be understood that the measurement report including the measurement result of the second cell(s) can be understood as that the network device configures the first threshold and/or the second threshold for the UE. Then, in response to the first threshold and/or the second threshold being configured in the reporting configuration, the UE may only report the measurement result of the second cell(s).

In an embodiment, if the reporting configuration includes the first threshold or the second threshold, the measurement result includes the cell(s) included in the second triggering cell list, that is, the second cell(s).

As an example, the above method may be implemented using a part or all of the following processes:
1. If there is at least one applicable neighboring cell:
2. If the reporting type is set to event-triggered (eventTriggered) or periodical trigger (periodical):
3. Set the neighbor cell measurement results (such as measResultNeighCells) to include the best neighboring cells determined according to the following rule, and the number of the best neighboring cells is not greater than the maximum number of report cells (such as maxReportCells):
4. If the reporting type is set to event-triggered:
5. If the corresponding reporting configuration (reportConfig) includes the first threshold (numberOfTriggeringCells) or the second threshold (numberOfNewTriggeringCells):
6. Include the cell(s) included in the second triggering cell list (newCellsTriggeredList) defined for the measurement identity (measId) in the second UE variable (such as VarMeasReportList) storing the measurement report list, or include the cell(s) included in the first triggering cell list (cellsTriggeredList) defined for the measurement identity in the second UE variable for which new measurement result(s) is(are) available since the last periodical reporting or since the initiation or re-initiation of the measurement;
5. Otherwise:
6. Include the cell(s) included in the first triggering cell list defined in the second UE variable for the measurement identity;
4. Otherwise:
5. Includes the available cells for which new measurement results are available since the last periodical reporting or since the initiation or re-initiation of the measurement.

In another embodiment, in response to the first threshold and/or the second threshold being configured in the reporting configuration, the UE may also give priority to reporting of the measurement result of the second cell. Here, giving priority to reporting may be understood as: the UE gives priority to reporting of the measurement result of at least one cell with the best measurement result in the second cell(s) to the network device according to the maximum value of the report cell(s) (e.g., maxReportCells).

As an example, it is assumed that the maximum value of the report cell(s) is 4, that is, the UE can report the measurement results of 4 cells at most. Then, the UE obtains 5 cells (i.e., the first cells) that fulfill the measurement event by measurement, and 4 cells among the 5 cells are the second cells. In this case, the UE may report the measurement results of the 4 second cells to the network device. Alternatively, the UE obtains 5 cells (i.e., the first cells) that fulfill the measurement event by measurement, and 3 cells among the 5 cells are the second cells. In this case, the UE may determine one cell with the best measurement result from two cells other than the second cells in the first cells, and report the measurement result of the one first cell and the measurement results of the three second cells to the network device. As a further example, the UE obtains 7 cells (i.e., the first cells) that fulfill the measurement event by measurement, and 5 cells among the 7 cells are the second cells. In this case, the UE may determine 4 cells with the best measurement results from the second cells, and report the measurement results of the 4 second cells to the network device. Of course, the above are only several examples of the UE preferentially reporting the measurement results of the second cells, and there may be other situations, which are not specifically limited in the embodiments of the present disclosure.

In some possible implementations, in a case where the UE initiates the measurement reporting in S204, the UE may also reset the first count value to 0. Here, the first count value is used to count the number of times of measurement reporting.

The first count value may be understood as a counter for counting the number of times the UE sends a measurement report, and each time a measurement report is sent, the first count value is incremented by 1. As an example, the first count value may be expressed as a numberOfReportsSent parameter in VarMeasReportList.

It can be understood that in S204, the UE initiates measurement reporting at least according to the second cell(s), that is, the number of cell(s) that fulfills(fulfill) the measurement event is continuously increasing. In this case, the UE needs to reset the number of reports sent to 0 to achieve continuous reporting by the UE.

In some possible implementations, in a case where the UE initiates measurement reporting through S204, the UE may further perform at least one of the following steps:
1. incrementing the value of the number of reports sent by 1;
2. if a periodical reporting timer is running, stopping the periodical reporting timer;
3. when the number of reports sent is less than the maximum number of times of reporting configured by the network, starting the periodical reporting timer;
4. sending measurement report(s) to the network.

Of course, the UE may also perform other steps according to the measurement configuration of the network device, and embodiments of the present disclosure does not specifically limit this.

The above methods will be described below with reference to a specific example.

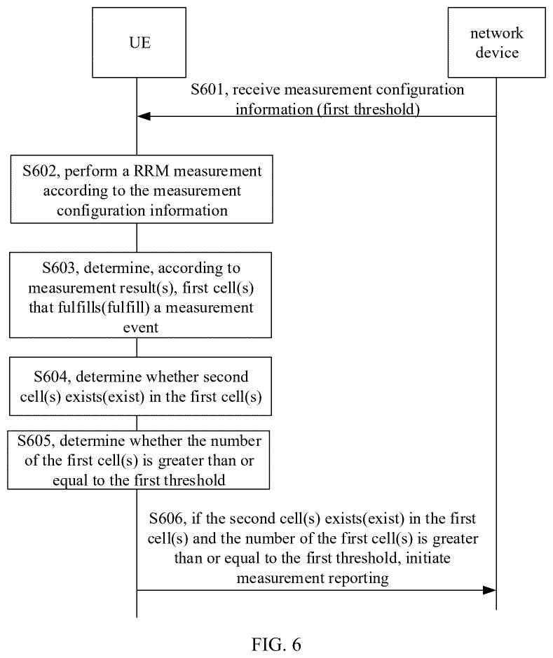

In an embodiment, FIG. 6 is a schematic diagram of an implementation process of a measurement reporting method in an embodiment of the present disclosure. Referring to FIG. 6, the measurement reporting method may include:

In S601, a UE receives measurement configuration information sent by a network device, where the measurement configuration information includes a first threshold.

In S602, the UE performs a RRM measurement according to the measurement configuration information.

In S603, the UE determines first cell(s) that fulfills(fulfill) a measurement event according to the measurement result(s).

In S604, the UE determines whether second cell(s) exists(exist) in the first cell(s).

In S605, the UE determines whether the number of the first cell(s) is greater than or equal to the first threshold.

In S606, if the second cell(s) exists(exist) in the first cell(s), and the number of the first cell(s) is greater than or equal to the first threshold, the UE initiates measurement reporting.

It should be noted that S604 and S605 may be performed successively or simultaneously, and the embodiment of the present disclosure does not limit this.

In the embodiment of the present disclosure, for the specific procedures for performing S601 to S606, reference can be made to the description of the UE side method steps in the embodiments of FIG. 2 and FIG. 3, and no specific limitation is made here for the sake of brevity of the specification.

In the embodiment of the present disclosure, each step in S601 to S606 may be performed independently or in combination, and any combination is within the protection scope of the present disclosure.

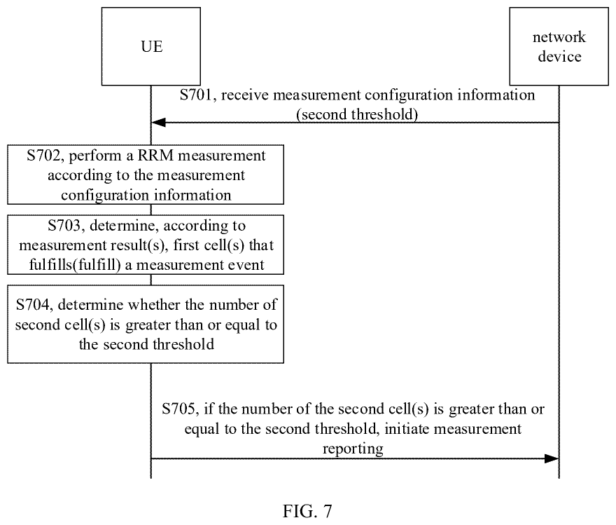

In another embodiment, FIG. 7 is a schematic diagram of an implementation process of a measurement reporting method in an embodiment of the present disclosure. Referring to FIG. 7, the measurement reporting method may include:

In S701, a UE receives measurement configuration information sent by a network device, where the measurement configuration information includes a second threshold (or a first threshold).

In S702, the UE performs a RRM measurement according to the measurement configuration information.

In S703, the UE determines first cell(s) that fulfills(fulfill) a measurement event according to the measurement result(s).

In S704, the UE determines whether the number of second cell(s) in the first cell(s) is greater than or equal to the second threshold (or the first threshold).

In S705, if the number of the second cell(s) is greater than or equal to the second threshold (or the first threshold), the UE initiates measurement reporting.

It should be noted that for the specific procedure for performing S701 to S705, reference can be made to the description of the UE side method steps in the embodiments of FIG. 2 and FIG. 4, and for the sake of brevity, repeated description is omitted here.

In the embodiment of the present disclosure, each step in S701 to S705 may be performed independently or in combination, and any combination is within the protection scope of the present disclosure.

The measurement reporting procedure at the UE side is completed so far.

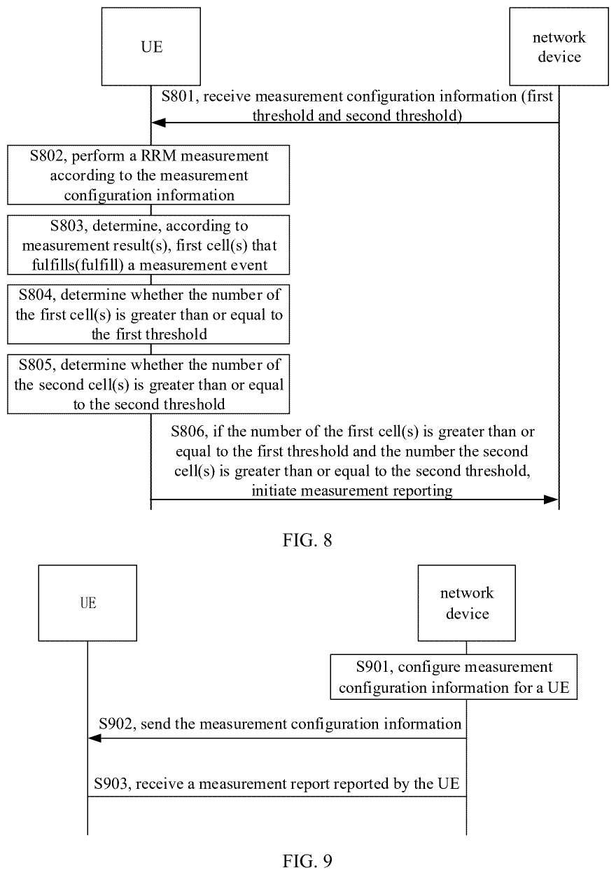

In yet another embodiment, FIG. 8 is a schematic diagram of an implementation process of a measurement reporting method in an embodiment of the present disclosure. Referring to FIG. 8, the measurement reporting method may include:

In S801, a UE receives measurement configuration information sent by a network device, where the measurement configuration information includes a first threshold and a second threshold.

In S802, the UE performs a RRM measurement according to the measurement configuration information.

In S803, the UE determines first cell(s) that fulfills(fulfill) a measurement event according to the measurement result(s).

In S804, the UE determines whether the number of the first cell(s) is greater than or equal to the first threshold.

In S805, the UE determines whether the number of second cell(s) in the first cell(s) is greater than or equal to the second threshold.

In S806, if the number of the first cell(s) is greater than or equal to the first threshold, and the number of the second cell(s) is greater than or equal to the second threshold, the UE initiates measurement reporting.

It should be noted that S804 and S805 may be performed successively or simultaneously, and the embodiment of the present disclosure does not specifically limit this.

In the embodiments of the present disclosure, for the specific procedure for performing S801 to S806, reference can be made to the description of the UE side method steps in the embodiments of FIG. 2 and FIG. 5, and no specific limitation is made here for the sake of brevity of the specification.

In the embodiment of the present disclosure, each step in S801 to S806 may be performed independently or in combination, and any combination is within the protection scope of the present disclosure.

The measurement reporting procedure at the UE side is completed so far.

In the embodiments of the present disclosure, cell(s) that was(were) not reported in the last measurement reporting, that is, new cell(s) that fulfills(fulfill) the measurement event, is(are) determined in the first cell(s) that fulfills(fulfill) the measurement event, and then measurement reporting is initiated based on the new cell(s). In this way, after measuring the unreported cell(s), the terminal device can decide to initiate measurement reporting to fully report to the network the measurement report(s) of the cell(s) associated with the terminal device, so that the network can have a more comprehensive understanding of the channel state(s) of the cell(s) associated with the terminal device, thereby improving system performance.

In some possible implementations, an embodiment of the present disclosure further provides a measurement reporting method. The method may be applied to a network device side in the above communication system.

FIG. 9 is a schematic diagram of an implementation process of a measurement reporting method in an embodiment of the present disclosure. Referring to FIG. 9, the method may include: S901 to S903.

In S901, a network device (such as a base station) configures measurement configuration information for a UE.

It can be understood that the network device configures configuration information for the UE to perform cell measurement, namely, the measurement configuration information. As an example, the measurement configuration information may include parameters such as measurement event(s), the maximum number of times of reporting, reporting period, or the like.

In some possible implementations, the measurement configuration information may include a first threshold, or the measurement configuration information may include a second threshold, or the measurement configuration information may include the first threshold and the second threshold.

In an embodiment, the first threshold and the second threshold may be two different parameters. The value of the second threshold is less than or equal to the value of the first threshold. The value of the second threshold is an integer greater than or equal to 1, and the value of the first threshold is an integer greater than or equal to 2. When the second threshold is 1, the number of the second cell(s) being greater than or equal to the second threshold may be understood as existence of second cell(s) in the first cell(s). Accordingly, the above first situation may also be described as: “when the number of the second cell(s) in the first cell(s) is greater than 1 (that is, the second threshold is 1), and the number of the first cell(s) is greater than or equal to the first threshold, the UE initiates measurement reporting”.

In another embodiment, the first threshold and the second threshold may be the same parameter. In this case, the first threshold and the second threshold have the same value. Accordingly, the measurement configuration information may include only one parameter (such as the first threshold) to indicate the first threshold and the second threshold at the same time.

In S902, the network device sends the measurement configuration information to the UE.

As an example, the network device may carry the measurement configuration information in RRC signaling and send it to the UE.

In S903, the network device receives a measurement report reported by the UE.

The measurement report may include: a measurement result of the first cell(s) or a measurement result of the second cell(s).

Optionally, after S903, the network device may perform procedure such as cell handover, interference detection, or interference coordination, or the like.

In some possible implementations, in response to the measurement configuration information including the second threshold and/or the first threshold, the network device configures the maximum number of times of reporting to 1 in S901. This may also be understood as: the network device can only configure the maximum number of times of reporting to 1.

In some possible implementations, in response to the measurement configuration information including the second threshold and/or the first threshold, the measurement configuration information in S901 does not include a parameter for indicating that reporting is triggered when a leaving condition is fulfilled, such as reportonleave. This may also be understood as: the measurement configuration information cannot include a parameter for indicating that reporting is triggered when a leaving condition is met.

It should be noted that the for the specific procedure for implementing S901 to S903, reference can be made to the description of the processes performed at the network device side in the embodiments of FIG. 2 to FIG. 8 above, and for the sake of brevity, repeated description will be omitted here.

The measurement reporting procedure at the network device side is completed so far.

In the embodiments of the present disclosure, cell(s) that was(were) not reported in the last measurement reporting, that is, new cell(s) that fulfills(fulfill) the measurement event, is(are) determined in the first cell(s) that fulfills(fulfill) the measurement event, and then measurement reporting is initiated based on the new cell(s). In this way, after measuring the unreported cell(s), the terminal device can decide to initiate measurement reporting, so that the network can receive measurement report(s) of all cell(s) associated with the terminal device, so that the network can have a more comprehensive understanding of the channel state(s) of the cell(s) associated with the terminal device, thereby improving system performance.

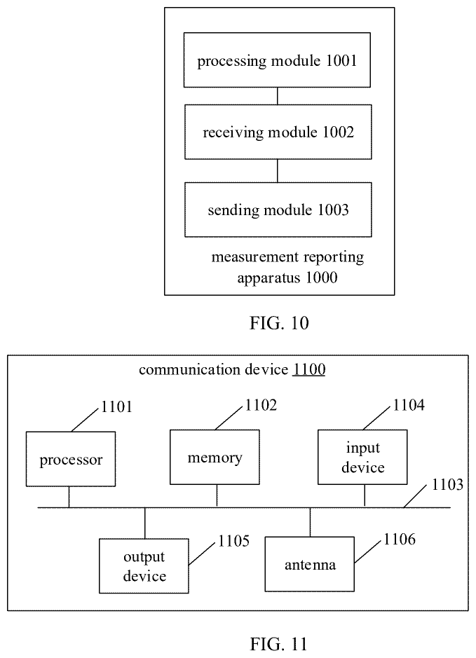

Based on the same inventive concept, an embodiment of the present disclosure provides a measurement reporting apparatus. FIG. 10 is a schematic structural diagram of a measurement reporting apparatus in an embodiment of the present disclosure. Referring to FIG. 10, the measurement reporting apparatus 1000 may include: a processing module 1001, a receiving module 1002 and a sending module 1003.

In some possible implementations, the measurement reporting apparatus may be a terminal device in a communication system or a chip or system on chip in the terminal device, or the measurement reporting apparatus may also be a functional module in the terminal device for implementing the methods of the above-mentioned embodiments. The measurement reporting apparatus may implement the functions performed by the terminal device in the above-mentioned embodiments, and these functions may be implemented by hardware executing corresponding software. The hardware or software includes one or more modules corresponding to the above-mentioned functions.

Correspondingly, the processing module 1001 is configured to perform a RRM measurement, and determine first cell(s) that fulfills(fulfill) the measurement event. The sending module 1003 is configured to initiate measurement reporting based on at least second cell(s) in the first cell(s), where the second cell(s) is(are) cell(s) in the first cell(s) that was(were) not reported in the last measurement reporting.

In some possible implementations, the sending module 1003 is configured to: determine that there is(are) second cell(s) in the first cell(s) and the number of the first cell(s) is greater than or equal to a first threshold; and initiate the measurement reporting.

In some possible implementations, the receiving module 1002 is configured to receive measurement configuration information sent by a network device, where the measurement configuration information includes the first threshold.

In some possible implementations, the sending module 1003 is configured to: determine the number of the second cell(s) in the first cell(s); determine that the number of the second cell(s) is greater than or equal to a second threshold; and initiate measurement reporting.

In some possible implementations, the receiving module 1002 is configured to receive the measurement configuration information sent by a network device, where the measurement configuration information includes the second threshold.

In some possible implementations, the sending module 1003 is configured to send a measurement report to the network device, where the measurement report includes: a measurement result of the first cell(s) or a measurement result of the second cell(s).

In some possible implementations, in response to the sending module initiating the measurement report, the processing module 1001 is further configured to reset a first count value to 0, where the first count value is used to count the number of times of measurement reporting.

In some possible implementations, the first cell(s) is(are) included in a first triggering cell list.

In some possible implementations, the second cell(s) is(are) included in a second triggering cell list.

In some possible implementations, in response to initiating the measurement report, the sending module 1003 is further configured to delete all cell(s) in the second triggering cell list.

In some possible implementations, the receiving module 1002 is configured to receive the measurement configuration information sent by the network device, where the measurement configuration information includes the first threshold and/or the second threshold. The sending module 1003 is further configured to send a measurement result to the network device, where the measurement result includes the second cell(s) in the second triggering cell list.

In some possible implementations, in response to initiating the measurement report, the processing module 1001 is further configured to reset the first count value to 0, where the first count value is used to count the number of times of measurement reporting.

In some possible implementations, the measurement reporting apparatus may also be a network device in a communication system or a chip or system on chip in the network device, or a functional module in the network device for implementing the methods of the above embodiments. The measurement reporting apparatus may implement the functions performed by the network device in the above embodiments, and the functions may be implemented by hardware executing corresponding software. The hardware or software include one or more modules corresponding to the above functions.

Correspondingly, the sending module 1003 is configured to send measurement configuration information to the terminal device, where the measurement configuration information includes a second threshold, the second threshold is the minimum value of the number of second cell(s) for the terminal device to initiate measurement reporting, the second cell(s) is(are) triggering cell(s) in the first cell(s) that was(were) not reported in the last measurement reporting, and the first cell(s) is(are) triggering cell(s) that fulfills(fulfill) a measurement event. The receiving module 1002 is configured to receive a measurement report reported by the terminal device.

In some possible implementations, the measurement report includes: a measurement result of the first cell(s) or a measurement result of the second cell(s).

In some possible implementations, the measurement configuration information further includes a first threshold, where the first threshold is the minimum value of the number of the first cell(s) for the terminal device to initiate measurement reporting.

In some possible implementations, in response to the measurement configuration information including the second threshold and/or the first threshold, the processing module 1001 is configured to configure the maximum number of times of reporting to 1.

In some possible implementations, in response to the measurement configuration information including the second threshold and/or the first threshold, the measurement configuration information does not include a parameter for indicating that reporting is triggered when a leaving condition is fulfilled.

It should be noted that for the specific procedure for implementing the processing module 1001, the receiving module 1002 and the sending module 1003, reference can be made to the detailed description of the UE and the network device in the embodiments of FIG. 2 to FIG. 7. For the sake of brevity of the specification, repeated description will be omitted here.

The receiving module 1002 mentioned in the embodiment of the present disclosure may be a receiving interface, a receiving circuit or a receiver, etc., the sending module 1003 may be a sending interface, a sending circuit or a transmitter, etc. ; the processing module 1001 may be one or more processors.

Based on the same inventive concept, an embodiment of the present disclosure provides a communication device, which may be a UE or a network device described in one or more of the above embodiments. FIG. 11 is a schematic diagram of the structure of a communication device in an embodiment of the present disclosure. Referring to FIG. 11, a communication device 1100 uses general computer hardware, including a processor 1101, a memory 1102, a bus 1103, an input device 1104, and an output device 1105.

In some possible implementations, the memory 1102 may include computer storage medium in the form of volatile and/or non-volatile memory, such as read-only memory and/or random access memory. The memory 1102 may store an operating system, application programs, other program modules, executable code, program data, user data, etc.

The input device 1104 may be used to input commands and information to the communication device. The input device 1104 may be, for example, a keyboard or a pointing device, such as a mouse, a trackball, a touch pad, a microphone, a joystick, a game pad, a satellite TV antenna, a scanner or a similar device. These input devices may be connected to the processor 1101 via the bus 1103.

The output device 1105 may be used to output information for the communication device. In addition to a monitor, the output device 1105 may also be other peripheral output device(s), such as a speaker and/or a printing device. These output devices may also be connected to the processor 1101 through the bus 1103.

The communication device may be connected to a network, such as a Local Area Network (LAN), via antenna 1106. In a networked environment, the computer-executable instructions stored in a control device may be stored in a remote storage device, rather than being limited to local storage.

When the processor 1101 in the communication device executes the executable code or application program stored in the memory 1102, the communication device implements the measurement reporting methods at the terminal device side or the network device side in the above embodiments. For the specific implementation procedure, reference may be made to the above embodiments and repeated description will be omitted here.

In addition, the memory 1102 stores computer-executable instructions for implementing the functions of the processing module 1001, the receiving module 1002, and the sending module 1003 in FIG. 10. The functions/implementation procedures of the processing module 1001, the receiving module 1002, and the sending module 1003 in FIG. 10 can all be implemented by the processor 1101 in FIG. 11 invoking the computer-executable instructions stored in the memory 1102. For specific implementation procedures and functions, reference can be made to the above-mentioned related embodiments.

Based on the same inventive concept, an embodiment of the present disclosure provides a terminal device. The terminal device is consistent with the UE in one or more of the above embodiments. Optionally, the terminal device may be a mobile phone, a computer, a digital broadcast terminal device, a messaging device, a gaming console, a tablet, a medical device, exercise equipment, a personal digital assistant, and the like.

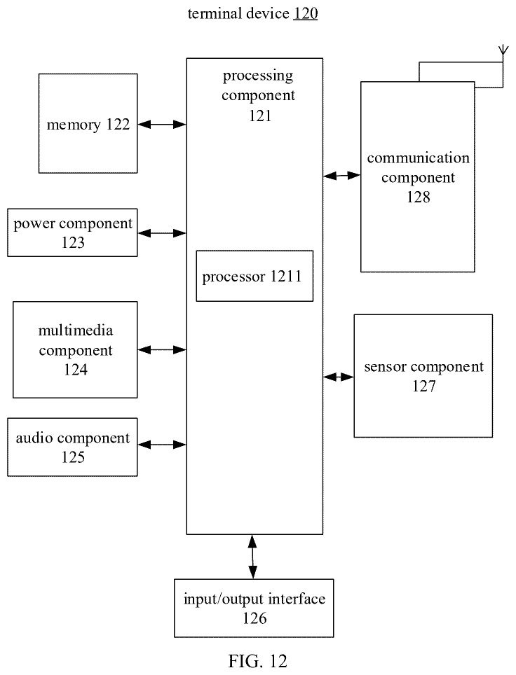

FIG. 12 is a structural diagram of a terminal device in an embodiment of the present disclosure. Referring to FIG. 12, the terminal device 120 may include one or more of the following components: a processing component 121, a memory 122, a power component 123, a multimedia component 124, an audio component 125, an input/output (I/O) interface 126, a sensor component 127, and a communication component 128.

The processing component 121 typically controls overall operations of the terminal device 120, such as the operations associated with display, telephone calls, data communications, camera operations, and recording operations. The processing component 121 may include one or more processors 1211 to execute instructions to perform all or part of the steps in the above described methods. Moreover, the processing component 121 may include one or more modules which facilitate the interaction between the processing component 121 and other components. For instance, the processing component 121 may include a multimedia module to facilitate the interaction between the multimedia component 124 and the processing component 121.

The memory 122 is configured to store various types of data to support the operation of the terminal device 120. Examples of such data include instructions for any applications or methods operated on the terminal device 120, contact data, phonebook data, messages, pictures, video, etc. The memory 122 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 123 provides power to various components of the terminal device 120. The power component 123 may include a power management system, one or more power sources, and any other components associated with the generation, management, and distribution of power in the terminal device 120.

The multimedia component 124 includes a screen providing an output interface between the terminal device 120 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 124 includes a front camera and/or a rear camera. The front camera and the rear camera may receive an external multimedia datum while the terminal device 120 is in an operation mode, such as a photographing mode or a video mode. Each of the front camera and the rear camera may be a fixed optical lens system or have focus and optical zoom capability.

The audio component 125 is configured to output and/or input audio signals. For example, the audio component 125 includes a microphone (“MIC”) configured to receive an external audio signal when the terminal device 120 is in an operation mode, such as a call mode, a recording mode, and a voice recognition mode. The received audio signal may be further stored in the memory 122 or transmitted via the communication component 128. In some embodiments, the audio component 125 further includes a speaker to output audio signals.

The I/O interface 126 provides an interface between the processing component 121 and peripheral interface modules, such as a keyboard, a click wheel, buttons, and the like. The buttons may include, but are not limited to, a home button, a volume button, a starting button, and a locking button.

The sensor component 127 includes one or more sensors to provide status assessments of various aspects of the terminal device 120. For instance, the sensor component 127 may detect an open/closed status of the terminal device 120, relative positioning of components, e.g., the display and the keypad, of the terminal device 120, a change in position of the terminal device 120 or a component of the terminal device 120, a presence or absence of user contact with the terminal device 120, an orientation or an acceleration/deceleration of the terminal device 120, and a change in temperature of the terminal device 120. The sensor component 127 may include a proximity sensor configured to detect the presence of nearby objects without any physical contact. The sensor component 127 may also include a light sensor, such as a CMOS or CCD image sensor, for use in imaging applications. In some embodiments, the sensor component 127 may also include an accelerometer sensor, a gyroscope sensor, a magnetic sensor, a pressure sensor, or a temperature sensor.

The communication component 128 is configured to facilitate communication, wired or wirelessly, between the terminal device 120 and other devices. The terminal device 120 can access a wireless network adopting a communication standard, such as WiFi, 2G, 3G, 4G, or 5G, or a combination thereof. In one example embodiment, the communication component 128 receives a broadcast signal or broadcast associated information from an external broadcast management system via a broadcast channel. In one example embodiment, the communication component 128 further includes a near field communication (NFC) module to facilitate short-range communications. For example, the NFC module may be implemented by adopting a radio frequency identification (RFID) technology, an infrared data association (IrDA) technology, an ultra-wideband (UWB) technology, a Bluetooth (BT) technology, and other technologies.

In example embodiments, the terminal device 120 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

Based on the same inventive concept, an embodiment of the present disclosure provides a network device. The network device is consistent with the base station in one or more of the above embodiments.

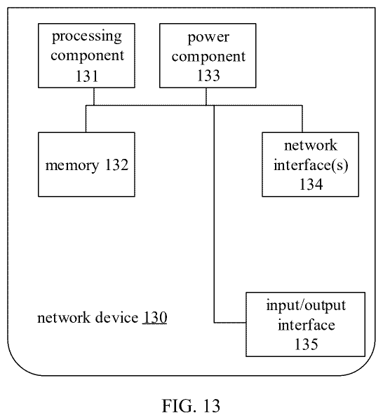

FIG. 13 is a schematic diagram of a structure of a network device in an embodiment of the present disclosure. Referring to FIG. 13, the network device 130 may include a processing component 131 that further includes one or more processors, and memory resources represented by a memory 132 for storing instructions executable by the processing component 131, such as application programs. The application programs stored in the memory 132 may include one or more modules each corresponding to a set of instructions. Further, the processing component 131 is configured to execute the instructions to perform any one of the above described methods which are applied at the network device.

The network device 130 may also include a power component 133 configured to perform power management of the network device 130, wired or wireless network interface(s) 134 configured to connect the network device 130 to a network, and an input/output (I/O) interface 135. The network device 130 may operate by adopting an operating system stored in the memory 132, such as Windows Server™, Mac OS X™, Unix™, Linux™, FreeBSD™, or the like.

Example embodiments are listed as follows.

According to an embodiment of the present disclosure, a measurement reporting method is provided. The method may be applied to a terminal device side in a communication system. The method may include: performing a RRM measurement; determining at least one first cell that fulfills a measurement event; and initiating measurement reporting at least according to at least one second cell in the at least one first cell, wherein the at least one second cell is at least one cell in the at least one first cell which was not reported in last measurement reporting.

In the present disclosure, the first cell(s) may be understood as cell(s) that fulfills(fulfill) the measurement event, and the second cell(s) may be understood as cell(s) in the first cell(s) that was(were) not reported in the last measurement reporting. Here, the cell(s) may include a serving cell of the terminal device, and may also include a neighboring cell of the terminal device.

Furthermore, the cell(s) that was(were) not reported in the last measurement reporting may be understood as cell(s) that has(have) never been reported by the terminal device in historical measurement report(s), or cell(s) that has(have) been reported by the terminal device in a historical measurement report but was(were) not reported in the last measurement reporting.

In some possible implementations, initiating measurement reporting at least according to the at least one second cell in the at least one first cell includes: determining that the at least one second cell exists in the at least one first cell and the number of the at least one first cell is greater than or equal to a first threshold; and initiating measurement reporting.

In the present disclosure, the first threshold may be understood as the minimum value of the number of cell(s) that fulfills the measurement event. For example, the first threshold may be expressed as numberOfTriggeringCells.

In some possible implementations, the method further includes: receiving measurement configuration information sent by a network device, where the measurement configuration information includes the first threshold.

In some possible implementations, initiating measurement reporting at least according to the at least one second cell in the at least one first cell includes: determining the number of the at least one second cell in the at least one first cell; and initiating measurement reporting when the number of the at least one second cell is greater than or equal to a second threshold.

In the present disclosure, the second threshold may be understood as the minimum value of unreported cell(s), or may be understood as the minimum value of the number of unreported cell(s) for initiating measurement reporting. For example, the second threshold may be expressed as numberOfNewTriggeringCells.

In some possible implementations, the method further includes: receiving measurement configuration information sent by a network device, where the measurement configuration information includes the second threshold.

In some possible implementations, initiating measurement reporting at least according to the at least one second cell in the at least one first cell includes: determining that the number of the at least one first cell is greater than or equal to the first threshold and the number of the at least one second cell is greater than or equal to the second threshold; and initiating measurement reporting.

In some possible implementations, the method further includes: receiving measurement configuration information sent by a network device, where the measurement configuration information includes the first threshold and/or the second threshold.

In some possible implementations, initiating measurement reporting includes: sending a measurement report to a network device, where the measurement report includes: a measurement result of the at least one first cell or a measurement result of the at least one second cell.

In some possible implementations, in response to initiating the measurement reporting, the method further includes: resetting a first count value to 0, where the first count value is used to count the number of times of measurement reporting.

In the present disclosure, the first count value may be represented as a numberOfReportsSent parameter in VarMeasReportList.

In some possible implementations, the at least one first cell is included in a first triggering cell list.

In the present disclosure, the first triggering cell list may be expressed as a cellsTriggeredList parameter.

In some possible implementations, the at least one second cell is included in a second triggering cell list.

In the present disclosure, the second triggering cell list may be expressed as a newcellsTriggeredList parameter.

In some possible implementations, in response to initiating measurement reporting, the method further includes: deleting all cell(s) in the second triggering cell list.

In some possible implementations, the method further includes: receiving measurement configuration information sent by a network device, where the measurement configuration information includes a first threshold and/or a second threshold, the first threshold is the minimum value of the number of first cell(s) for the terminal device to initiate measurement reporting, and the second threshold is the minimum value of the number of second cell(s) for the terminal device to initiate measurement reporting. Initiating measurement reporting includes: sending a measurement result to the network device, where the measurement result includes second cell(s) in the second triggering cell list.

According to an embodiment of the present disclosure, a measurement reporting method is provided. The method may be applied to a network device side in a communication system. The method may include: sending measurement configuration information to a terminal device, where the measurement configuration information includes a second threshold, the second threshold is the minimum value of the number of at least one second cell for the terminal device to initiate measurement reporting, the at least one second cell is at least one triggering cell in at least one first cell that was not reported in last measurement reporting, and the at least one first cell is at least one triggering cell that fulfills a measurement event; and receiving a measurement report reported by the terminal device.

In some possible implementations, the measurement report includes: a measurement result of the first cell(s), or a measurement result of the second cell(s).

In some possible implementations, the measurement configuration information further includes a first threshold, where the first threshold is the minimum value of the number of first cell(s) for the terminal device to initiate measurement reporting.

In some possible implementations, in response to the measurement configuration information including the second threshold and/or the first threshold, the method further includes: configuring the maximum number of time(s) of reporting to be 1. For example, the maximum number of time(s) of reporting may be represented as reportAmount.

In some possible implementations, in response to the measurement configuration information including the second threshold and/or the first threshold, the measurement configuration information does not include a parameter for indicating that reporting is triggered when a leaving condition is fulfilled. For example, the parameter may be expressed as reportonleave.

According to an embodiment of the present disclosure, a measurement reporting apparatus is provided. The measurement reporting apparatus may be a terminal device in a communication system or a chip or a system on chip in the terminal device, or a functional module in the terminal device for implementing the methods of the above-mentioned embodiments. The measurement reporting apparatus may implement the functions performed by the terminal device in the above-mentioned embodiments, and these functions may be implemented by hardware executing corresponding software. The hardware or software includes one or more modules corresponding to the above-mentioned function(s). The measurement reporting apparatus includes: a processing module configured to perform a RRM measurement and determine at least one first cell that fulfills a measurement event; and a sending module configured to initiate measurement reporting at least according to at least one second cell in the at least one first cell, where the at least one second cell is at least one cell in the at least one first cell that was not reported in last measurement reporting.

In some possible implementations, the sending module is configured to: determine that the at least one second cell exists in the at least one first cell and the number of the at least one first cell is greater than or equal to a first threshold; and initiate measurement reporting.

In some possible implementations, the apparatus further includes: a receiving module configured to receive measurement configuration information sent by a network device, where the measurement configuration information includes the first threshold.

In some possible implementations, the sending module is configured to determine the number of the at least one second cell in the at least one first cell; determine that the number of the at least one second cell is greater than or equal to a second threshold; and initiate measurement reporting.

In some possible implementations, the apparatus further includes: a receiving module configured to receive measurement configuration information sent by a network device, where the measurement configuration information includes the second threshold.

In some possible implementations, the sending module is configured to determine that the number of the at least one first cell is greater than or equal to a first threshold and the number of the at least one second cell is greater than or equal to a second threshold; and initiate measurement reporting.

In some possible implementations, the apparatus further includes: a receiving module configured to receive measurement configuration information sent by a network device, where the measurement configuration information includes the first threshold and the second threshold.

In some possible implementations, the sending module is configured to send a measurement report to the network device, where the measurement report includes: a measurement result of the first cell or a measurement result of the second cell.

In some possible implementations, in response to the sending module initiating the measurement reporting, the processing module is further configured to reset a first count value to 0, where the first count value is used to count the number of time(s) of measurement reporting.

In some possible implementations, the first cell(s) is included in a first triggering cell list.

In some possible implementations, the second cell(s) is included in a second triggering cell list.

In some possible implementations, in response to initiating the measurement report, the sending module is further configured to delete all cell(s) in the second triggering cell list.

In some possible embodiments, the apparatus further includes a receiving module configured to receive measurement configuration information sent by a network device, where the measurement configuration information includes a first threshold and/or a second threshold, the first threshold is the minimum value of the number of first cell(s) for the terminal device to initiate measurement reporting, and the second threshold is the minimum value of the number of second cell(s) for the terminal device to initiate measurement reporting; the sending module is further configured to send a measurement result to the network device, where the measurement result includes the second cell(s) in the second triggering cell list.

In some possible implementations, in response to initiating the measurement report, the processing module is further configured to reset a first count value to 0, where the first count value is used to count the number of time(s) of measurement reporting.

According to an embodiment of the present disclosure, a measurement reporting apparatus is provided. The measurement reporting apparatus may be a network device in a communication system or a chip or a system on chip in the network device, or may also be functional module(s) in the network device for implementing the methods of the above-mentioned embodiments. The measurement reporting apparatus may implement the function(s) performed by the network device in the above-mentioned embodiments, and the function(s) may be implemented by hardware executing corresponding software. The hardware or software includes one or more modules corresponding to the above-mentioned function(s). The measurement reporting apparatus includes: a sending module configured to send measurement configuration information to a terminal device, where the measurement configuration information includes a second threshold, the second threshold is the minimum value of the number of at least one second cell for the terminal device to start measurement reporting, the at least one second cell is at least one triggering cell in at least one first cell that was not reported in last measurement reporting, and the at least one first cell is at least one triggering cell that fulfills a measurement event; and a receiving module configured to receive a measurement report reported by the terminal device.

In some possible implementations, the measurement report includes: a measurement result of the first cell(s), or a measurement result of the second cell(s).

In some possible implementations, the measurement configuration information further includes a first threshold, where the first threshold is the minimum value of the number of first cell(s) for the terminal device to initiate measurement reporting.

In some possible implementations, in response to the measurement configuration information including the second threshold and/or the first threshold, the apparatus further includes: a processing module configured to configure the maximum number of time(s) of reporting to 1.

In some possible implementations, in response to the measurement configuration information including the second threshold and/or the first threshold, the measurement configuration information does not include a parameter for indicating that reporting is triggered when a leaving condition is fulfilled.

According to an embodiment of the present disclosure, a communication device is provided, such as a terminal device. The communication device includes: an antenna; a memory; and a processor which is connected to the antenna and the memory respectively and is configured to control reception and transmission of the antenna by executing computer-executable instructions stored in the memory, and is capable of implementing the method in any one of the embodiments as described above.

According to a sixth aspect of the present disclosure, a communication device is provided, such as a network device. The communication device includes: an antenna; a memory; and a processor which is connected to the antenna and the memory respectively and is configured to control reception and transmission of the antenna by executing computer-executable instructions stored in the memory, and is capable of implement the method in any one of the embodiments as described above.

Based on the same inventive concept, for example, a terminal device includes: an antenna; a memory; a processor, which is connected to the antenna and the memory respectively, and is configured to control transmission and reception of the antenna by executing computer-executable instructions stored in the memory, and can implement the method at the terminal device side according to one or more of the above embodiments.

Based on the same inventive concept, a network device includes: an antenna; a memory; a processor, which is connected to the antenna and the memory respectively, and is configured to control transmission and reception of the antenna by executing computer-executable instructions stored in the memory, and can implement the method at the network device side according to one or more of the above embodiments.

Based on the same inventive concept, an embodiment of the present disclosure also provides a computer-readable storage medium, in which instructions are stored; when the instructions are run on a computer, the method at the terminal device side or the network device side according to one or more of the above embodiments is implemented.

Based on the same inventive concept, an embodiment of the present disclosure also provides a computer program or a computer program product. When the computer program product is executed on a computer, the computer is caused to implement the method at the terminal device side or the network device side according to one or more of the above embodiments.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A measurement reporting method, performed by a terminal device, the method comprising:
performing a Radio Resource Management (RRM) measurement;
determining at least one first cell that fulfills a measurement event; and
initiating measurement reporting at least according to at least one second cell in the at least one first cell, wherein the at least one second cell is at least one cell in the at least one first cell which was not reported in last measurement reporting.

2. The method according to claim 1, wherein initiating measurement reporting at least according to the at least one second cell in the at least one first cell comprises:
determining that the at least one second cell exists in the at least one first cell and the number of the at least one first cell is greater than or equal to a first threshold; and
initiating measurement reporting.

3. The method according to claim 1, wherein initiating measurement reporting at least according to the at least one second cell in the at least one first cell comprises:
determining that the number of the at least one second cell in the at least one first cell is greater than or equal to a second threshold; and
initiating measurement reporting.

4. The method according to claim 3, further comprising:
receiving measurement configuration information sent by a network device, wherein the measurement configuration information comprises the second threshold.

5. The method according to claim 1, wherein initiating measurement reporting at least according to the at least one second cell in the at least one first cell comprises:
determining that the number of the at least one first cell is greater than or equal to a first threshold and the number of the at least one second cell is greater than or equal to a second threshold; and
initiating measurement reporting.

6. The method according to claim 5, further comprising:
receiving measurement configuration information sent by a network device, wherein the measurement configuration information comprises the first threshold, or the measurement configuration information comprises the second threshold, or the measurement configuration information comprises the first threshold and the second threshold.

7. The method according to claim 1, wherein the at least one first cell is comprised in a first triggering cell list.

8. The method according to claim 1, wherein the at least one second cell is comprised in a second triggering cell list.

9. The method according to claim 8, wherein, in response to initiating measurement reporting, the method further comprises:
deleting all of at least one cell in the second triggering cell list.

10. The method according to claim 8, further comprising:
receiving measurement configuration information sent by a network device, wherein the measurement configuration information comprises a first threshold, or the measurement configuration information comprises a second threshold, or the measurement configuration information comprises the first threshold and the second threshold, the first threshold is a minimum value of the number of at least one first cell for the terminal device to initiate measurement reporting, and the second threshold is a minimum value of the number of at least one second cell for the terminal device to initiate measurement reporting; and
wherein initiating measurement reporting comprises:
sending a measurement result to the network device, wherein the measurement result comprises at least one second cell in the second triggering cell list.

11. The method according to claim 1, wherein in response to initiating measurement reporting, the method further comprises:
resetting a first count value to 0, wherein the first count value is used to count the number of times of measurement reporting.

12. The method according to claim 1, wherein initiating measurement reporting comprises:
sending a measurement result of the at least one first cell or a measurement result of the at least one second cell to a network device.

13. A measurement reporting method, performed by a network device, the method comprising:
sending measurement configuration information to a terminal device, wherein the measurement configuration information comprises a second threshold, the second threshold is a minimum value of the number of at least one second cell for the terminal device to initiate measurement reporting, the at least one second cell is at least one triggering cell in at least one first cell which was not reported in last measurement reporting, and the at least one first cell is at least one triggering cell that fulfills a measurement event; and
receiving a measurement report reported by the terminal device.

14.-15. (canceled)

16. A communication device, comprising: an antenna; a memory; and a processor connected to the antenna and the memory respectively and configured to control transmission and reception of the antenna by executing computer executable instructions stored in the memory,
wherein when the computer executable instructions are executed by the processor, the communication device is caused to:
perform a Radio Resource Management (RRM) measurement;
determine at least one first cell that fulfills a measurement event; and
initiate measurement reporting at least according to at least one second cell in the at least one first cell, wherein the at least one second cell is at least one cell in the at least one first cell which was not reported in last measurement reporting.

17. A non-transitory computer storage medium storing instructions, wherein when the instructions are run on a computer, the method according to claim 1 is implemented.

18. A communication device, comprising: an antenna; a memory; and a processor connected to the antenna and the memory respectively and configured to control transmission and reception of the antenna by executing computer executable instructions stored in the memory, wherein when the computer executable instructions are executed by the processor, the communication device is caused to perform the method according to claim 13.

19. A non-transitory computer storage medium storing instructions, wherein when the instructions are run on a computer, the method according to claim 13 is implemented.

20. The method according to claim 13, wherein the measurement configuration information does not include a parameter for indicating that reporting is triggered when a leaving condition is fulfilled.

21. The communication device according to claim 16, wherein when the computer executable instructions are executed by the processor, the communication device is caused to:
determine that the at least one second cell exists in the at least one first cell and the number of the at least one first cell is greater than or equal to a first threshold; and
initiate measurement reporting.

22. The communication device according to claim 16, wherein when the computer executable instructions are executed by the processor, the communication device is caused to:
determine that the number of the at least one second cell in the at least one first cell is greater than or equal to a second threshold; and
initiate measurement reporting.
